(19) United States
(12) Patent Application Publication
(10) Pub. No.: US 2003/0147380 A1
(43) Pub. Date: Aug. 7, 2003

(54) Implementation of services in an ip telephone network

(76) Inventor: Tuomas Hakuli, Kempele (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/203,588

(22) PCT Filed: Feb. 7, 2001
(86) PCT No.: PCT/FI01/00108

(30) Foreign Application Priority Data
Feb. 9, 2000 (FI) 20000277

(51) Int. Cl. H04L 12/66

(52) U.S. Cl. 370/352; 370/350

(57) ABSTRACT

The invention is based on a distributed service architecture. The invention utilizes one or more agents for offering and supplying a service to a user. An agent includes service data and functions for executing a service. Furthermore, when necessary the agent is capable of moving in a packet-based telephone network to a part of the network where it can best execute the service desired by the user. An individual network element must incorporate one or more execution platforms providing the agent with the facility to execute services, communicate with other agents, and utilize the resources of the network element.

### FIELD OF THE INVENTION

The present invention relates to systems that switch calls in packet-based networks, such as mobile communications networks utilizing IP technology. The invention specifically relates to telephony services offered in said networks.

### BACKGROUND OF THE INVENTION

In conventional networks, calls are connected in a circuit-switched manner, which means that a fixed connection for the transmission is established between the starting point and the destination point. This connection is not the same as the control channel used in the establishment therefore.

In a circuit-switched network, speech or data can be transmitted. A fixed 64 kbit/s (analog) or 2*64kbit/s (ISDN) bandwidth is always allocated for this purpose, said bandwidth in some cases being far too broad. For example a speech session may contain long silences, during which no payload is transported in the network at all, from the users' point of view. Nevertheless, increasingly the breadth of a fixed bandwidth is becoming too small, because the fixed network is often used as an access network to the Internet network, where the bandwidth requirement is often greater. In such cases, the access network constitutes a bottleneck.

In addition to speech, subscribers in a conventional telephone network are offered various services, the most popular of these being call transfer, call waiting and hold. These services must be implemented at the local exchange of the telephone user. This means that if it is desired that the service be operative nation-wide, each local exchange in the country must support said service. This considerably retards the commissioning of the service.

FIG. 1 shows an example of a line hunting service of a conventional telephone network. Line hunting is a service in which the call of the A subscriber is placed on a hunting group. From this group, a free subscriber is hunted to which the call is eventually set up.

Line hunting is a service of the B subscriber. This means that the A subscriber is not necessarily aware of the existence of the service. A typical subscriber to this service wishes to improve his accessibility; for example the hunting group may include a number of clerks at a travel agency. When a client calls a travel agent, a clerk who is currently vacant is selected from the group, and the call is eventually set up to him.

When the A subscriber calls the calling number of the line hunting group, the call control (CC) of the telephone exchange searches the data of the B subscriber from a database DB. Therefrom information is obtained that a line hunting service is concerned. The database also stores a list of the members of the group as well as information about the method of selecting the member. On the basis of this data, execution of the service is initiated, and the service starts hunting for a free member. It uses carrier sensing as an aid in this, wherein the status information of the member is requested from a subscriber module. The group size may be several hundred members, and a wide variety of methods are available for selecting the member, such as random search. When a free member is finally found, the telephone exchange routes the call to this number, and the telephone starts ringing there. If the ring is not answered, a new member is not sought and the call setup is unsuccessful.

A subscriber to the group is not capable of managing the information about the group. This can only be done by the operator maintaining the exchange, for example by means of prior art MML (Man Machine Language) commands. In the conventional application, all members of the group must be subscribers at the same telephone exchange, and their status information is to be found at said exchange.

It is also known to switch calls in packed-based telephone networks. The underlying basis of the global packet-based network is the Internet technology, even though other technologies exist as well. The protocol used in the Internet is IP; its task is to transport the packets from the source address to the destination address. Routers between networks supporting the IP protocol handle the delivery of the packets. For this purpose, they use their routing tables, containing information about neighbouring routers. If one router is removed from the Internet, the routers automatically attend to updating the routing tables by means of the routing protocol.

A user in the IP network can contact all machines in the Internet, if this has not been specifically prevented with a firewall. A conventional telephone network employs a regional hierarchical structure, which is a considerable difference compared to the Internet, in which the hierarchy is based on organisations. On account of the hierarchy differences, it is difficult to distinguish domestic and international calls. The organisational boundary in large enterprises often extends beyond country borders, and thus the cost of an international call is the same as that of a domestic call.

In the global Internet, it is difficult to ensure speech quality, since the load on and performance of transport networks between the local networks in different areas vary greatly. To solve this problem, enterprises—so called Clearing Houses—which network operators can join have emerged. Each network operator grants resources for the use of the Clearing House, thus enabling high-quality calls between the different network operators. The Clearing Houses assist the network operators, since thus they need not make a separate contract with every network operator but a contract with the Clearing House suffices. Also other strategies are emerging for improving and ensuring speech quality.

At present, telephone operators use the IP network mainly for switching the international calls of a conventional telephone network. In such a case, the network used is not the common Internet, but often the operator's own network which it manages. Speech quality is ensured by means of a sufficiently large capacity.

In an IP-based telephone network, services offered by the network are needed. The call can be placed directly from terminal to terminal, but this is only seldom possible, since the support of the network servers is needed to reach a person in the network. IP addresses are seldom permanently tied to one device, and in most cases dynamic IP addresses are employed. At the start of a new network connection, an IP address is obtained that is normally different from the one used in the previous network connection session. For this reason, in telephone network usage a server with which network users register each time a network connection is started is needed in the network. The network address of the user is stored in connection with the registration, and thus he can be reached by other users of the network.

The access of computers to the Internet network and speech transfer in an IP network makes it possible to integrate existing computer applications into the telephony application. For example, an agenda on a computer can be incorporated to interwork with the telephony application, and thus by clicking at the name of a person in the agenda a call to that person is automatically set up.

FIG. 2 shows by way of example what elements must be provided in the network in order to produce the above line hunting service functionality utilizing the resources of the IP network, also taking into account the limitations. The implementation includes terminals, a telephone server, and a database that can also be integrated into the telephone server. A pure IP-to-IP model, in which all terminals have computing capability, is concerned here, and the conventional telephone network is not used at any stage.

In an IP network, the call setup of the A subscriber can apply to the telephone server or directly to another terminal. This determines the location of the list containing the group members.

Since the line hunting service is a service of the B subscriber, the list cannot be located with the calling subscriber. Instead, it can be located in the database of the telephone server or at one of the terminals, which may be external to the group or a member of the group. Besides the list and the calling number, the status information of the terminals constitutes a third element. On the basis of this information it is known whether the terminal has an ongoing call or not. In a conventional telephone network, the status information can be obtained from the information maintained at the exchange. In an IP application, obtaining the status information is much more difficult, since the terminals are not physically connected to the server and to one another.

FIGS. 3 and 4 show examples of two different ways of implementing a line hunting group in a packet network. FIG. 3 depicts a model routed via a telephone server, the operation of which is largely comparable to the implementation of a conventional telephone network.

In a model routed via a telephone server, the services pass through the telephone server. This enables storing of the status information of the terminal in the internal status information tables or database of the telephone server. Upon receiving a call request on the group, the telephone server retrieves the information about the group and performs a quick search in the status information table, and selects the member to whom the call is directed. Conventional line sensing is not needed.

The advantage of this model is rapid call setup, since the status information about the terminals is directly found on the telephone server and need not be requested from the terminals across the network Another advantage is the centralized location of the service logic at one point, and the terminals need not support said service. A third advantage is the reliability of operation of the service, since redundancy can be provided for the telephone server and its load can be distributed to several discrete servers.

When the model routed via a telephone server is used, the actual terminal to which the call has been eventually set up can be masked from terminal A. It cannot call directly the terminal that responded.

FIG. 4 illustrates how the call setup message of the A subscriber is steered directly to the terminal managing the group. This terminal realizes the line hunting service.

The terminal receiving the call setup message manages the group and maintains a list of the group members. It could also make a search in an external database, but on account of the limited resources of the terminal the list should preferably be maintained at the terminal. The terminal managing the group is not aware of the status of the members of the group, since the members of the group do not route their signalling through it. The status information must be obtained in some other way.

There are two possibilities for this, alternatives (a) and (b) in FIG. 4:

(a) The terminal managing the group interrogates the members as to who of them is free and can receive a call. This resembles carrier sensing in the conventional telephone network and is not as rapid a method as a search in a status information table as carried out in the model routed via a telephone server.

(b) The terminals of the members of the group inform the terminal managing the group of transactions. Transactions include call initiation and termination. Thus, the terminal managing the group is aware of the status of the terminals, and the selection of a member is a rapid search in the status information table of that terminal.

Both alternatives are attended by the drawback that the telephony application of each terminal must support a service that has not been standardized.

When the terminal managing the group receives information on a free member, it informs the A subscriber that it must route the call to a new address. This requires support from the terminal of the A subscriber, said support being forwarding service H.450-3 in accordance with H.323. The managing terminal cannot route the call forward like a telephone server can.

Direct routing to the terminal can be considered a poor model in view of the reliability of the service, since if the receiving terminal is not connected to the network, provisioning of the service fails altogether. On the other hand, the terminal must have high performance.

In the method using a telephone server, wherein the line hunting group is offered as a service, the terminals need not support the line hunting group or supplementary services. All necessary information is located at the telephone server. Another alternative is to operate without a telephone server, in which case the terminals belonging to the group must incorporate a line hunting group application and the A subscriber must support the forwarding service. Speech quality may be good without a telephone server, if there is sufficient bandwidth in the network. However, this is an expensive solution that is wasteful of resources.

A packet-switched telephone network based on the IP protocol and a conventional telephone network can also be combined. Packet networks are becoming increasingly comprehensive and fast, which enables speech transmission in real time. At the moment, conventional telephone networks almost entirely dominate the speech transmission market, but the situation has been predicted to change. On the packet network side, technologies have been introduced that can be made use of in improving existing telephony services of a conventional network and completely new-ones can be created.

FIG. 5 shows an example of a combined telephone network comprising telephone network elements in accordance with the current standards. The most significant element in view of the combination of the networks is the Gateway (GW), which performs a conversion between the representations of the different network types. The most significant elements in view of telephony services are the telephone servers: Gatekeeper (GK), which can perform the same tasks as a telephone exchange but is also capable of providing a wide variety of other services and performing tasks that can only be offered in a packet network, and the SIP server (Session Initiation Protocol), by means of which Internet connections between terminals can be established, changed, and terminated.

The current call signalling standards of an IP network are H.323 of ITU-T and SIP of IETF. The responsibility for H.323 is at Study Group 16 (SG 16) of ITU-T, and it is based on the ISDN specification of the conventional network. The services of the conventional telephone network are obtained from H.323 by means of value added services in accordance with the supplementary H.450. At the moment, H.450 comprises call deflection and call forwarding services. Additional features to be forthcoming include call waiting and hold.

SIP of IETF is based on the Internet standards and mainly on HTTP. IETF has attached less weight to the potential of the conventional network and thus mainly sees it as one application among others.

The signalling standards enable communication of devices and internetworking by using universally known and understood messages. Signalling enables call setup between terminals without the users being aware of the actual location of the terminal. On the basis of a numbering scheme or aliases, the servers are capable of routing the signalling to the destination address.

At its simplest, signalling comprises messages for setting up and terminating a call. In addition, services such as putting a call on hold can be offered by means of signalling. A telephonic connection can also be established between more than one terminal.

At the moment, mobile networks include supplementary services that require the support of said network to be operative. In other words, if the supplementary service does not exist in the network, it cannot be offered to the user. In practice the situation is such that the most common supplementary services such as call waiting, hold, call transfer, are operative anywhere but there is no support for the more ‘exotic’ services. Oftentimes the services are standardized and hence greatly restrict the inventive imagination.

It has been attempted to diminish the standard-dependence of services by means of Intelligent Network technology. In a mobile environment, the operation can be for example as follows:

When the user roams in a foreign country/network, he switches his telephone set on. In that situation, the SSP (Service Switching Point) of the IN makes a database query to the HLR. Therefrom the initiation information relating to the services that are available to the user is obtained, along with information as to where the Service Control Point (SCP) is located. When the user makes a call, the call control is started on the basis of the initiation data obtained. Thereafter a call is made to the service control point, which returns for example modified number. The drawback of IN solutions is that queries to the service control point must be made in the system.

The drawback of the known techniques is the dependence of the services on a limited portion of the network. For example in a circuit switched network the local exchange incorporates the services of subscribers under the exchange. In order for the subscriber-specific services to be operative for example nation-wide, each local exchange in the country must support these services. This will slow down the commissioning of the service.

In packet networks, the local exchange is replaced by a telephone server. Many services are based on standardized solutions. In order for the service to be executable for example in a given country, all telephone servers in that country must support the desired services. This is not always the case, since all telephone servers do not support all standardized services. Furthermore, there are services that are not tied to standards. If the telephone network supports the service, the network capacity must be loaded, so that the service can be provided from the telephone server incorporating the service to the user, who can roam in the operating are of another telephone server. Configuring the services to correspond to user needs is also difficult. The present invention aims at minimizing these drawbacks of the prior-art in a packet-based telephone network.

### BRIEF SUMMARY OF THE INVENTION

The invention is based on a distributed service architecture. The invention makes use of one or more agents for providing and executing a service to a user. The agent comprises service data and functions for executing the service. Furthermore, when necessary the agent is capable of moving in a packet-based network to a part of the network in which it can best execute the service desired by the user. An individual network element must comprise one or more execution platforms, providing the agent with the facility to execute the service, communicate with other agents, and utilize the resources of the network element The aim of the invention is achieved in the way set forth in the claims.

### LIST OF DRAWINGS

In the following, the invention will be described in detail with reference to the examples in accordance with FIGS. 6-12, set forth in the accompanying drawings, in which

FIG. 1 shows an example of a line hunting service of a conventional telephone network,

FIG. 2 shows an example of a line hunting service of an IP network,

FIG. 3 shows an example of a line hunting service of an IP network, routed via a telephone server,

FIG. 4 shows an example of a line hunting service of an IP network, routed directly to a terminal,

FIG. 5 shows an example of combining packet-switched and circuit-switched telephone networks,

FIG. 6 shows two examples of provisioning of services based on agents,

FIG. 7 shows an example of interface agents,

FIG. 8 shows an example of a service architecture in accordance with the invention,

FIG. 9 shows an example of the agent's moving from one server to another when the user roams geographically,

FIG. 10 shows an example of executing a service when the user is located in the network area of a foreign telephone server,

FIG. 11 shows an example of the use of interface agents for converting external signalling to the internal format of call control,

FIG. 12 shows an example of a line hunting service implemented in accordance with the invention,

FIG. 13 shows an example of an abbreviated dialing service implemented in accordance with the invention.

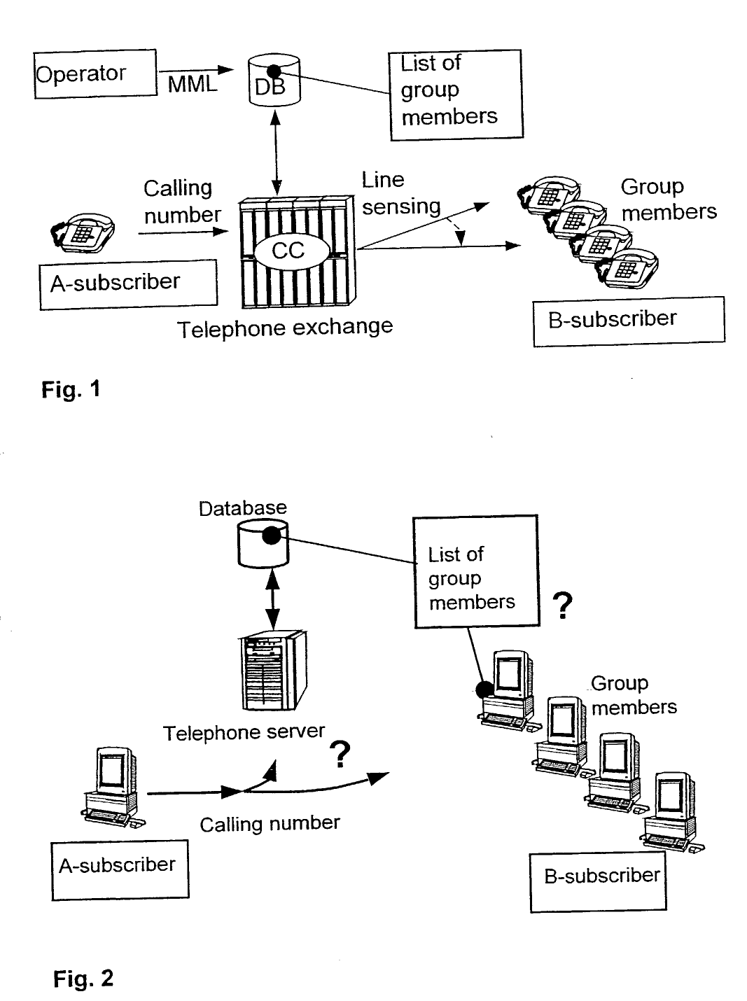

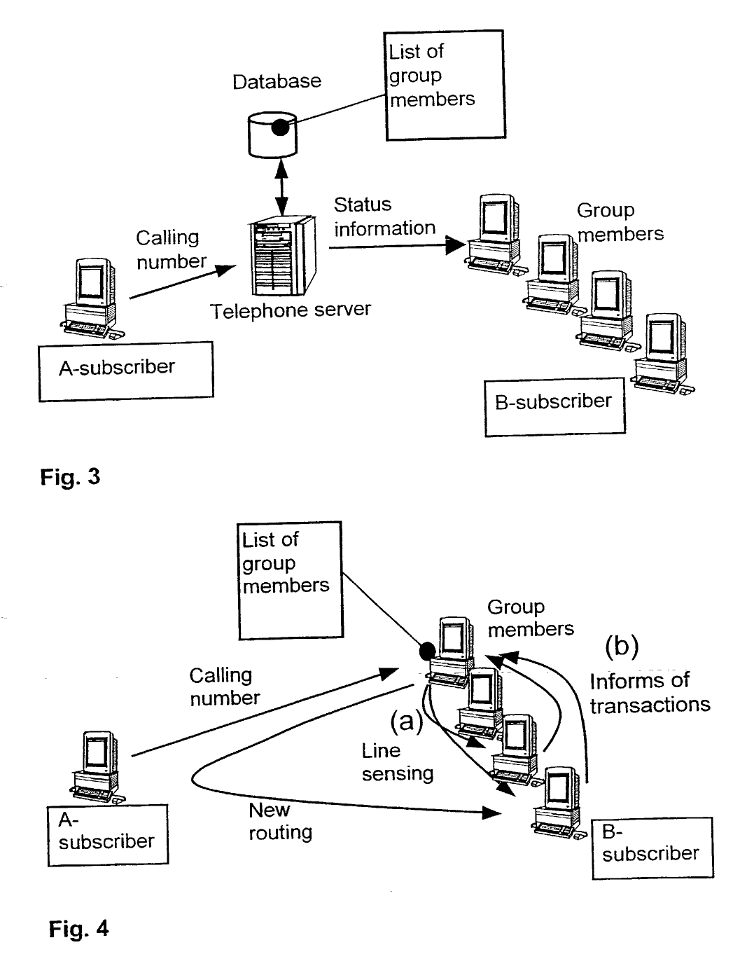

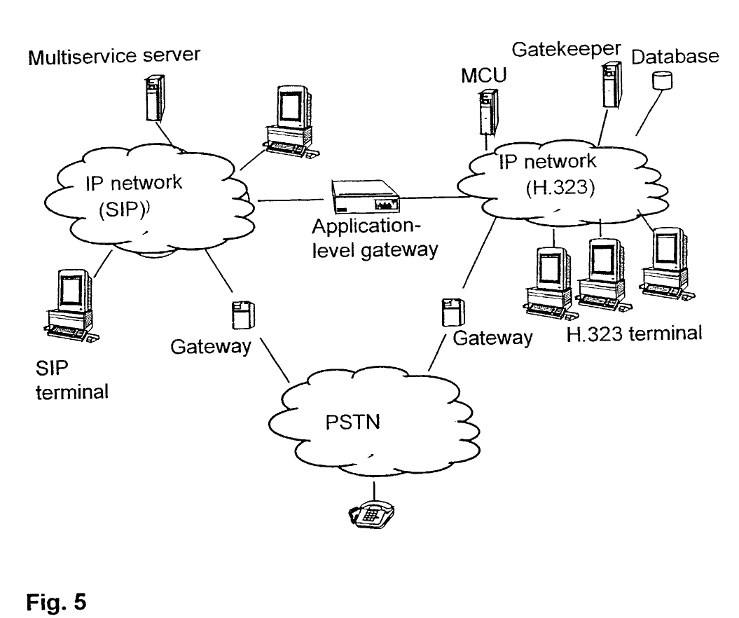

### DETAILED DESCRIPTION OF THE INVENTION

The agents to be utilized in the network in accordance with the invention are programs that comprise information and functions for performing tasks assigned to the agent. The properties of the agents can be defined in brief:

Agents are capable of observing things,

Agents are capable of performing operations on the basis of the observations,

Agents are aware of things, and

Agents are capable of moving from one location to another.

Agents are often compared to objects (a program with interfaces to other programs), but these are not directly comparable, since objects are passive. They wait until they are invoked, and only thereafter are executed. Agents, on the other hand, are autonomic, i.e. active and goal-oriented. They operate on the basis of current information together with other agents and learn from experience. On the basis of these properties, agents can be classified e.g. as smart, interworking, interworking-learning and interface agents.

The agent model is a distributing technique differing from the conventional distribution methods, since the agents can move from one device to another. The devices in the network must have an execution platform for the agents to enable moving and execution of the agents. The execution platform grants the agent the right to perform, provides mechanisms for communicating with other agents, and offers access to a limited number of the resources of the device. Execution platforms are commercially available, e.g. IBM's Aglets execution platforms.

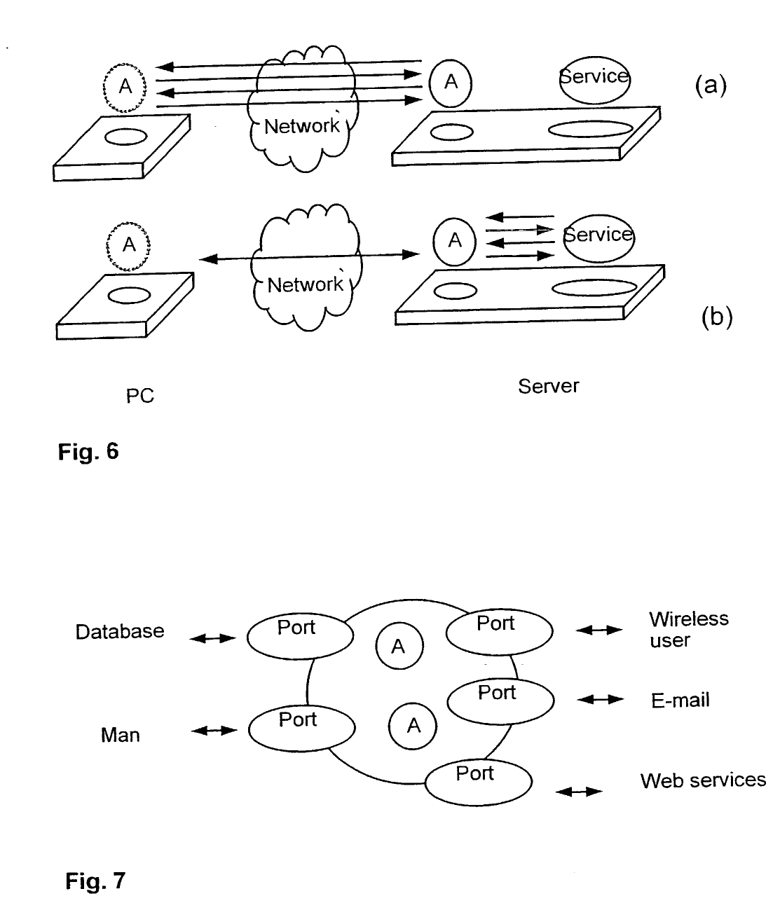

Interworking agents (particularly mobile ones) are of the greatest interest in view of the distribution and services. FIG. 6 illustrates the alternatives that a mobile agent has conventionally been construed as having to call upon a service. It can make the call across the network (a) or relocate to the service (b), in which case the call is made as a local call. Several methods are emerging for communication between agents, the most frequently used ones being KIF (Knowledge Interchange Format) and KQML (Knowledge Query and Manipulation Language).

The use of mobile agents offers two advantages:

Tactical advantage. It is worth-while for the agent to move to the service if the size of the agent is small compared to the requisite number of calls. The greater the number of calls required to perform the task, the greater the advantage to be gained by mobility. This advantage will become significant particularly when the network is slow. The speed of the present-day local networks is of such an order that the time taken up by one call is very small. But in situations where the network is accessed through a conventional telephone network or a wireless connection, the execution time for calls will increase considerably and the use of a mobile agent will afford significant advantage. In the case of the conventional telephone network, significant advantage is gained in such a way that the requisite data connection must be active only during the time the agent moves to the network. Thereafter the connection can be cut off. The agent will perform the operation, in the network and when it returns a new connection to the network is established, and thus the agent can return.

Strategic advantage. If it is wished to configure the operation of the server to the mode desired by a specific user, the entire server application need not be reworked but only an agent is composed that will execute the desired additional functionality. The same principle can be utilized in updating software. A small amendment in the software can be made automatically by means of an agent moving in the network, and no updating by the user is necessary.

Also interfacing functions can be implemented with agents. Interface agents serve as a gateway to the agent system. They operate as relayers of calls between external units and agents within the agent system. Their task is to convert external calls into the internal format of the agent system. FIG. 7 shows examples of interface agents.

In addition to -the above alternatives, it is also possible to employ mobile agents to transport services in the solution in accordance with the invention. If the service is not too heavy to be transported in the network, it can be integrated into the agent, and thus it moves together with the agent in the network. Such a service may be for example a number scheme for abbreviated dialing, which will be described later hereinbelow. If the service is too heavy to be moved in the network, for example the above alternative b (FIG. 6) may be the most advantageous way of implementing the service. It is also possible that part of the service is integrated into the mobile agent and the remainder of the service is integrated into a ‘home telephone server’ (corresponds to a local exchange in a conventional network). In that case, the mobile agent makes the requisite interrogations to said telephone server. It is preferable to incorporate the services on the telephone server into the user's home agent, which thus remains on the telephone server and has contact with the mobile agent.

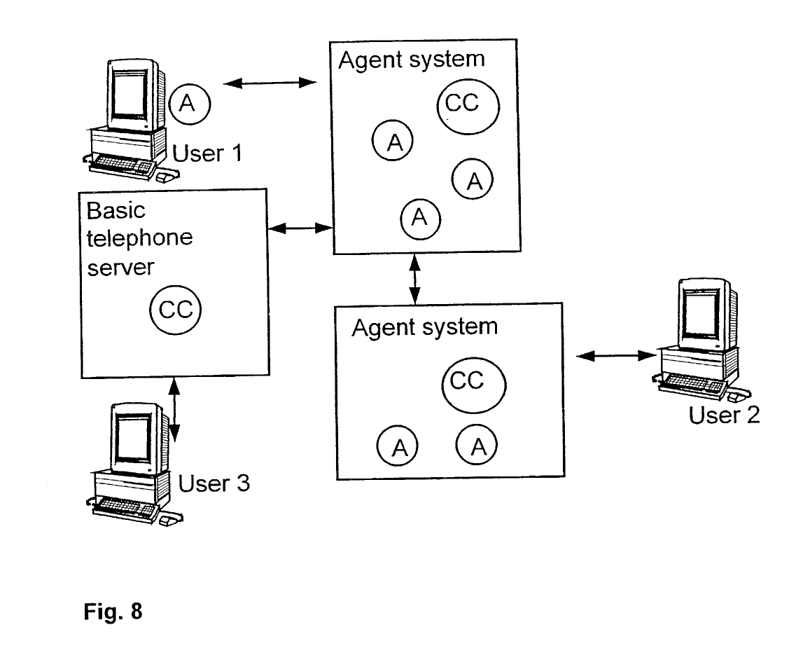

The invention has been implemented with a distributed agent-based system (FIG. 8) in which the telephony services are catered for in a distributed manner with the aid of agents (A). The distributed service architecture is based on a model routed via a telephone server. Each agent system incorporates call control (CC), capable of setting up basic calls between the users. The task of the agents is to enhance the functionality of the system in the manner desired by the user. There may be a plurality of agents depending on the number of users. The agents are personal user agents.

The agents may also be service-related, for example to offer service to a given target group, such as an organization, association, etc . . . The service can be offered e.g. to the members of a specific organization, the members residing in different areas geographically. The above-stated line hunting service can be construed as a service serving a specific target group.

The emphasis of the architecture lies in the network. The terminal only need support the signalling properties required for basic calls. In keeping with the model of the conventional telephone network, the terminal only has minimum intelligence. This makes possible the functionality of a plurality of telephony applications and services when products of different manufacturers are used.

The basic call will succeed using a telephone server and a signalling standard. The telephone server incorporates a call control process offering basic call services. The operation of the server can be tailored to suit the specific user by employing an agent managing the call control. The agent can be tailored by the user himself, or it may have been produced by the manager of the network and transported to the network.

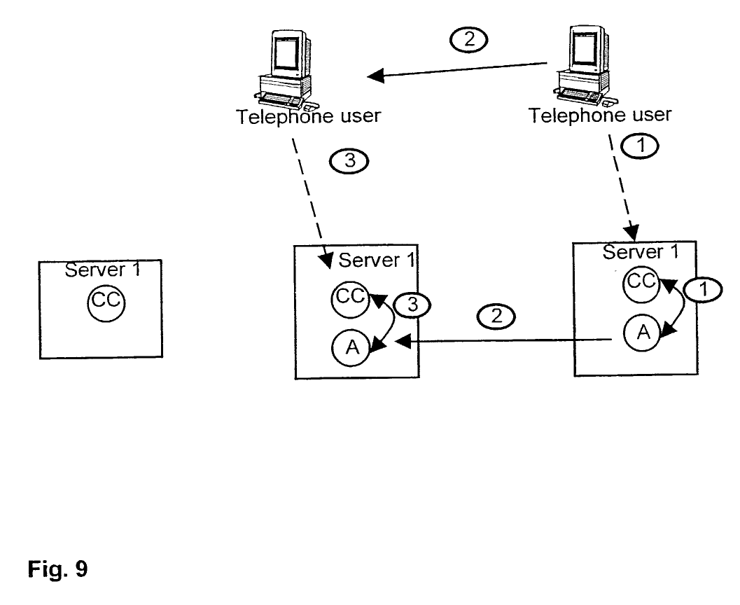

Hence, the service can move in the network when the agent relocates from one server to another following the user, as in FIG. 9. Moving in the network takes place without the user knowing it. Actually, the user need not even be aware of the existence of the agent, but he only notices that the service is successful. To enable mobility, the telephone servers must incorporate an execution platform for the agents. In addition, a mechanism must be provided for indicating the location where the desired service agent resides.

An interface must be provided for the call control CC, through which the agent performs the control. A basic call is always successful even though the agent were not capable of moving. For example, the interface in accordance with CS1 used in IN solutions can be used in an agent system. By means of the Connect operation of CS1, for instance, a number conversion for realizing an abbreviated dialing service can be performed. Detection Points DP of CS1 are excellent interfacing points between the call control and the agent.

The mobile agent follows the user on the basis of known user location data. For example the HLRNLR structure known from the mobile communication system can be utilized. When the user registers with the VLR of a foreign base station area, information is sent to the HLR on the location of the user. The agent can check this information at the HLR and relocate on the basis thereof after the user e.g. to a network element whose VLR the user is registered with. It is preferable that the mobile agent moves to the telephone server in the area of which the user is located. In such a case, the communication between the mobile agent and the call control on the telephone server is easy and rapid. However, it must be taken into account that, when necessary, the mobile agent is also capable of moving to a terminal in the network if the terminal incorporates an execution platform for the agent.

In view of availability, it would be good if the user's network address would always remain the same when he roams from one network to another. In practice, however, this is difficult to realize, since when the user roams to another network the routers in the network must be informed of the move if it is desired that the network address always remain the same. This will place a load on the network, since there is a very large number of routers to be updated.

A distributed service architecture can employ for example also the method known from 3G.IP for accessing the user. 3G.IP strives at solving the user availability problem by using the HLR/VLR mechanism of the GSM telephony system. In 3G.IP, these registers have been renamed as Home Subscriber Server (HSS) and Call State Control Function (CSCF). When the user registers with the network, the registering always takes place with the CSCF. This can take place anywhere in the world, which is why the network operators must allow network visitations.

The user identifier/telephone number is determined on the basis of the home subscriber server (i.e., the home telephone server). Each network user must have a home subscriber server through which all call requests are routed. The home subscriber server is aware of the location of the user, and thus it can route the calls to the call state control function with which the user is registered.

Hence, the distributed service architecture needs support from a home subscriber server and a call state control function. These elements must be capable of receiving service agents and granting them a right of execution.

To enable the stability and mobility of telephony services, it is preferable for the home subscriber server to incorporate a home agent (KA) that is always aware of the location of the user. In addition to the home agent, a user-related network agent (VA) moving in the network is needed, following the user from one call state control function to another in response to the registering performed by the user. When the user registers, the server must receive information as to where the user's home subscriber server is located in order to be able to invoke the network agent. The home agent and network agent together attend to provisioning the service to the user in such a way that the network agent is aware of and capable of providing the most common and simplest services independently. When need arises, it can ask the home agent for help in providing services that place a heavy load on the network (e.g. an announcement can be with the home subscriber server).

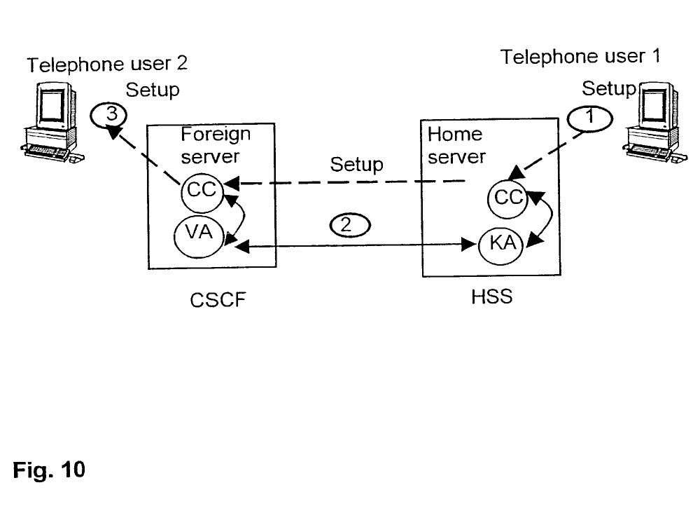

FIG. 10 shows an example of how a service can be transported to a user when he is located within the area of a foreign telephone server. User 1 wishes to place a call SETUP to user 2, in which situation the call control CC of the home subscriber server in the home server of user 2 receives a call request (1). The home agent (KA) of user 2, which is in possession of the location data of user 2, informs the call control of this and also informs the network agent (VA) of the incoming call. The call control directs the call to the call control of the call state control function (CSCF in the foreign server), which further routes the call to user 2. If the call involves services, the network agent and the home agent execute the service desired by the user. If the service is simple, the network agent can execute it on its own, but if the service is heavier, interworking with the home agent may be needed.

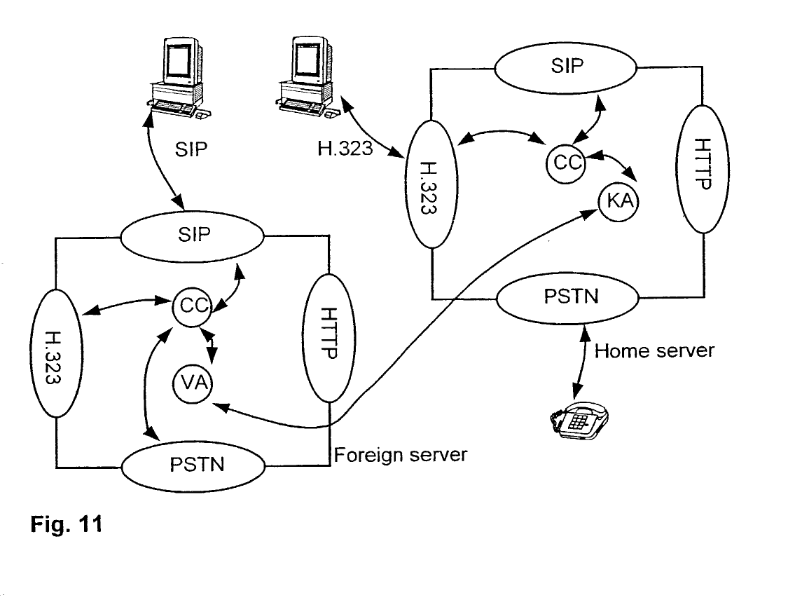

An important role of the agents is to serve as interface agents. A telephone server can support a number of signalling standards by using interface agents converting external signalling into the internal format of the agent system. In this case, the internal call control always operates independently of what type of signalling is used by the external terminals. FIG. 11 shows interface agents SIP, H.323 and PSTN, converting the signalling into the internal format. Through the HTTP interface agent, the user can configure his services. Only the call control entities communicate through the interface agents. The user's personal agents communicate directly with one another using prior art methods.

The call control (CC) communicates with both interface agents and service agents. In FIG. 11, the telephony application of an SIP user employs an SIP interface agent, and an H.323 user employs an H.323 interface agent. The call control is capable of routing the calls to the correct interface agent by using the agent services.

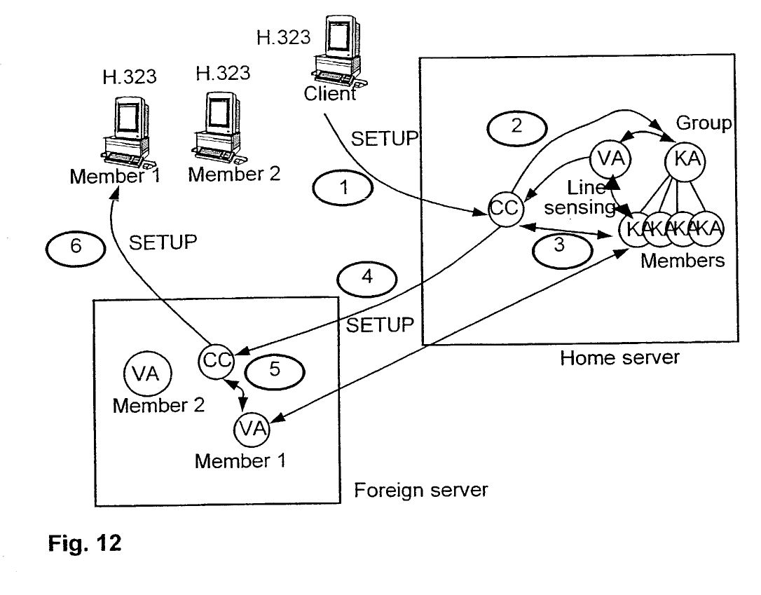

Implementing a line hunting service by means of the service architecture in accordance with the invention is a very straightforward process in line with the above examples. FIG. 12 shows an example of the principle of a line hunting service in accordance with the invention and of the proceeding of a SETUP message from the client eventually to the selected member of the hunting group. The operation has been simplified in such a way that each terminal employs H.323 signalling, and thus no interface agents are needed. The line hunting service has been restricted from users in such a way that the home subscriber server of all members of the group must be the same as the home subscriber server of the group. This follows the model of the conventional telephone network and enables faster line sensing.

In view of the operation of the line hunting service, two factors need to be clarified:

Where is the list of the group members located?

Where is the status information of a group member obtained from for the purposes of?

In the following, it will be described in detail how the line hunting service can be implemented in the solution in accordance with the invention using the denotations in FIG. 12:

1) The call control of the home subscriber server of the group receives a SETUP message from a client.

2) The call control CC invokes the home agent KA of the group, which further invokes the network agent VA of the group. The network agent maintains a list of the group members, wherefrom it selects a member according to any search method. After the selection, it performs line sensing by requesting the home agent of the selected member for status information, in other words, the home agent must always be aware of the status of the member. The status information could also be maintained with the network agent, but it is faster to perform the line sensing locally with an agent on the same server. Once a free member (member 1) has been found, the network agent of the group returns information to the call control as to whom the call should be routed to.

3) The call control CC invokes the home agent of the selected group member, said agent returning the location and address of the member to the call control. The home agent can inform the network agent of the transaction, in which case it can be prepared for steering the call control of the call state control function.

4) The call control routes the call to the call control of the call state control function.

5) The call control of the call state control function requests instructions from the network agent of the group member, which has been waiting for this request.

6) The group member eventually receives a SETUP message.

The call setup proceeds normally from here according to the model routed via a telephone server. The home agent and network agent of the group no longer participate in the further setup of the call. The user agents (network agent and home agent) of the group member, on the other hand, participate in the control during the entire duration of the call.

When the member becomes free, his network agent informs his home agent that the member is free to receive the next call. If the member himself makes a call, his network agent likewise informs his home agent of the change in the status of the member.

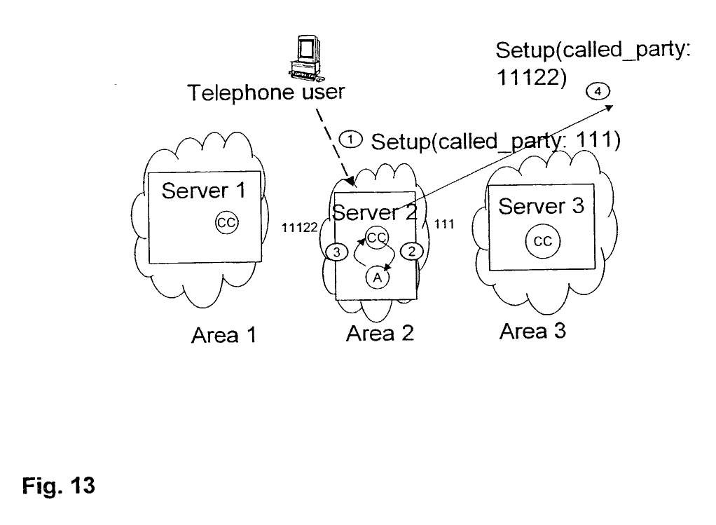

FIG. 13 shows an example in which the entire service is transported in the network together with the network agent, following the location of the user. The user roams in area 2, in whose telephone server (2) the network agent A of the user is also located. The user wishes to make a call to number 11122, but he uses the abbreviated dialing number 111 that he recalls. The call control CC requests the network agent for the number corresponding to the abbreviated dialing number, known to the network agent, which the network agent gives as a response. The call control can now route the call to the number desired by the user.

In this way, the solution in accordance with the invention can be used to diminish the drawbacks of the prior art techniques. The service is not restricted to any specific area of the network, but can always be provided to the user. The services are not tied to standards, and they are easily tailored in accordance with user needs. In the distributed solution in accordance with the invention, the network need not be loaded as much as in the earlier solutions in order to offer services to the user. The invention has been described in the above in the light of examples, but it is obvious that the invention can also be applied to implementing telephony services of other kinds within the scope of the inventive idea.

1. A packet-based telephone network in which telephony services are offered to a user, said network including at least one telephone server comprising call control means, characterized in that for offering telephony services, the network comprises:
user-related agents including user-specific telephone service data and functions for executing services, and being capable of moving, when necessary, in the telephone network to an individual network element,
at least one execution platform in an individual network element, providing the user-related agent with the facility to execute services, communicate with other agents, and utilize the network resources.

2. A network as claimed in claim 1, wherein a home telephone server has been defined for an individual user of the network, characterized in that the user's home telephone server comprises an agent including all user-specific services and service data.

3. A network as claimed in claim 1, characterized in that the network further comprises a mobile agent including user-specific telephony services and service data.

4. A network as claimed in claim 1, characterized in that the user's home telephone server comprises an agent including all user-specific services and an agent moving in the network, including user-specific telephony services and service data.

5. A network as claimed in claim 4, characterized in that the interface between the agent on the user's home telephone server and the agent moving in the network is an application-related interface between the agents.

6. A network as claimed in claim 4, characterized in that the interface between the agent on the user's home telephone server and the agent moving in the network is a prior art standard interface.

7. A method for implementing telephony services in a packet-based telephone network, characterized in that one or more agents including user-specific telephone service data and functions for executing the services execute the service desired by the user in such a way that when necessary, the agent can relocate in the telephone network to an individual network element to execute the service, and when necessary utilize the resources of the network element to execute the service, said network element comprising one or more execution platforms providing the agent with the facility to execute services, communicate with other agents, and utilize the network resources.

8. A method as claimed in claim 7, characterized in that the agent including all user-specific services of the user is permanently tied to an individual network element, wherein when the user roams in the operational area covering said element the user has all user-specific services at his disposal.

9. A method as claimed in claim 7, characterized in that the agent moving in the network includes user-specific telephone service data that it can execute at any network element.

10. A method as claimed in claim 8 and claim 9, characterized in that the agent moving in the network and the agent including all user-specific services of the user, which is permanently tied to an individual network element, co-operate in executing the service desired by the user.

11. A method as claimed in any one of claims 7-10, characterized in that the user-specific service is changed by reconfiguring the user agent, without any need to make changes in the resources of the user's home subscriber server.

12. A method as claimed in any one of claims 7, 9, 10 or 11, characterized in that the agent moving in the network utilizes the user location data available to the network upon moving in the network.

13. A method as claimed in claim 12, characterized in that the agent moving in the network relocates to the network element in the operational area of whose telephone server the user is located.
